(19) United States
(12) Patent Application Publication
(10) Pub. No.: US 2014/0109714 A1
(43) Pub. Date: Apr. 24, 2014

(54) CROSS AXIS RAKE AND TELESCOPE LOCK

(71) Applicant: STEERING SOLUTIONS IP HOLDING CORPORATION, Saginaw, MI (US)

(72) Inventor: Joen C. Bodtker, Gaines, MI (US)

(73) Assignee: STEERING SOLUTIONS IP HOLDING CORPORATION, Saginaw, MI (US)

(21) Appl. No.: 13/656,083

(22) Filed: Oct. 19, 2012

(51) Int. Cl. B62D 1/187

(52) U.S. Cl. 74/493

(57) ABSTRACT

An adjustable rake and telescope steering column is provided. The steering column includes a rake bracket having a first leg and a second leg, a steering shaft extending within an upper jacket along a first axis between the first and second legs, a telescope clamp positioned about the upper jacket and a telescope lock connected to the telescope clamp and configured to operate the telescope clamp to selectively apply a first clamping force to the upper jacket to secure the steering shaft against adjustment in a telescope direction. An actuating lever is coupled to a rake bolt, the rake bolt extending along a second axis through the first leg and second leg and spaced from the upper jacket. A rake lock is positioned on the rake bolt and configured to selectively apply a second clamping force in a direction along the second axis to secure the steering shaft against adjustment in the rake direction.

### BACKGROUND OF THE INVENTION

The description relates to a rake and telescope lock of an adjustable steering column, and in particular, a rake and telescope clamp individually adjustable along different directions.

Adjustable steering columns may be adjustable in a rake direction and a telescope direction. A traditional adjustable steering column includes a jacket clamp positioned about a steering column jacket and configured to apply a clamping force to the steering column jacket to prevent adjustment of the steering column in the telescope direction. In addition, a traditional adjustable steering column may include a rake clamp configured to apply a clamping force to the jacket clamp and/or steering column jacket to prevent adjustment of the steering column in the rake direction. The adjustable steering column is in a locked condition when the telescope clamp and rake clamp respectively apply clamping forces to prevent adjustment of the adjustable steering column in the rake and telescope and directions. The adjustable steering column is in an unlocked condition when respective clamping forces from the telescope clamp and rake clamp are released so that the steering column may be adjusted.

A lever may be actuated between a first position corresponding to the locked condition of the adjustable steering column and a second position corresponding to the unlocked condition of the adjustable steering column. More specifically, the lever rotates a bolt extending through the rake clamp and jacket clamp. Rotation of the bolt in one direction causes the rake clamp and jacket clamp to apply a clamping force to lock the steering column against adjustment. Rotation of the bolt in an opposite direction causes the rake clamp and jacket clamp to release a clamping force to unlock the steering column such that the steering column may be adjusted in the rake and telescope directions. That is, rotation of the lever actuates the adjustable steering column between locked and unlocked conditions.

Adjustable steering columns are generally designed and manufactured with five performance characteristics in mind: 1) high stiffness while clamped or locked, 2) high holding load while clamped or locked, 3) low resistance to adjustment while unclamped or unlocked, in two axes of motion, 4) low effort to actuate a lever between positions corresponding to clamped and unclamped conditions of adjustable steering assembly, and 5) low travel distance for the lever when actuating the adjustable steering column between clamped and unclamped conditions. Typically, certain performance characteristics must be sacrificed in order to improve others. For example, a reduction in the travel distance for the lever to actuate the adjustable steering column has traditionally increased the effort required to actuate the lever. Conversely, when effort to actuate the lever is reduced, stiffness and holding load tend to be reduced as well. In addition, the travel distance for the lever to actuate the adjustable steering column increases.

Further, in the traditional adjustable steering columns, the jacket clamp and rake clamp are adjusted together via rotation of the single bolt extending along a single axis. As a result, the jacket clamp and rake clamp cannot be individually tuned or adjusted to be installed in different applications. That is, any adjustment of a preload along the single bolt is applied equally to the rake clamp and jacket clamp.

Accordingly, it is desirable to provide and adjustable steering column where clamped/locked holding load and unclamped/unlocked adjustment effort performance characteristics are met, while also satisfying performance characteristics related to the effort required to actuate the lever between clamped and unclamped positions. In addition, it is desirable to provide an adjustable steering column where preload to a rake clamp and jacket clamp may be individually adjusted for use in various platforms.

### SUMMARY OF THE INVENTION

According to one exemplary embodiment, there is provided an adjustable rake and telescope steering column including a rake bracket having a first leg and a second leg, a steering shaft extending within an upper jacket along a first axis between the first leg and second leg, a telescope clamp positioned about the upper jacket, and a telescope lock connected to the telescope clamp and configured to operate the telescope clamp to selectively apply a first clamping force to the upper jacket to secure the steering shaft against adjustment in a telescope direction. An actuating lever is coupled to a rake bolt, the rake bolt extending along a second axis through the first leg and second leg and spaced from the upper jacket, and a rake lock is positioned on the rake bolt and configured to selectively apply a second clamping force in a direction along the second axis to secure the steering shaft against adjustment in the rake direction.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a side view of an adjustable steering column according to an exemplary embodiment of the present invention;

FIG. 2 is a front view of an adjustable steering column according to an exemplary embodiment of the present invention;

FIG. 3 is a cross section view taken at C-C in FIG. 1 of an adjustable steering column according to an exemplary embodiment of the present invention;

FIG. 4 is a cross section taken at D-D in FIG. 1 of an adjustable steering column according to an exemplary embodiment of the present invention; and

FIG. 5 is a front view cross section of an adjustable steering column according to an alternative exemplary embodiment of the present invention.

### DETAILED DESCRIPTION

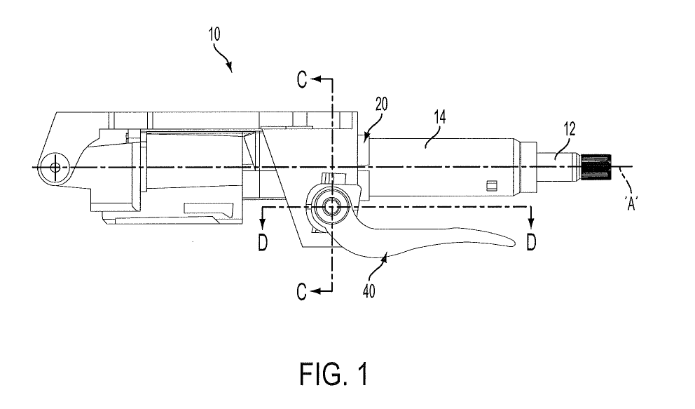

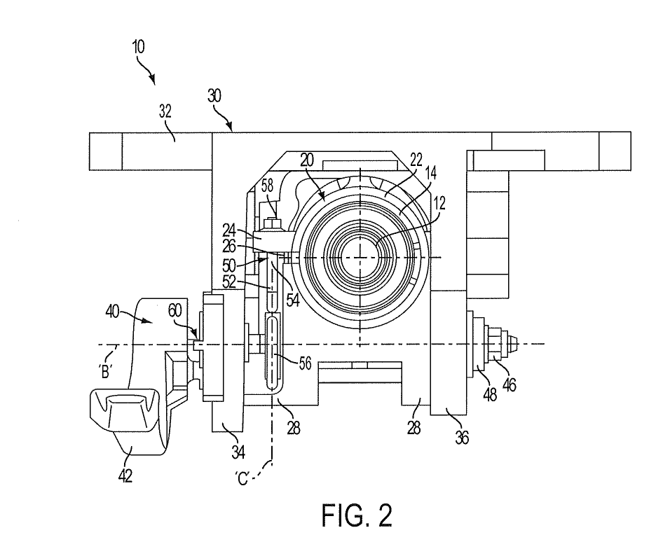

Referring now to the Figures, where the invention will be described with reference to specific embodiments, without limiting same, FIG. 1 is a side view of an adjustable steering column 10 according to an exemplary embodiment of the present invention. FIG. 2 is a front view of the adjustable steering column 10 shown in FIG. 1. With reference to FIG. 1, the adjustable steering column 10 includes a steering shaft 12 and an upper jacket 14 positioned about the steering shaft 12. Referring to FIGS. 1 and 2, the adjustable steering column 10 also includes a telescope clamp 20, a rake bracket 30, an actuating lever 40, a telescope lock 50 and a rake lock 60. In an exemplary embodiment, the steering shaft 12 of the adjustable steering column 10 is adjustable in a rake direction and a telescope direction.

The steering shaft 12 extends along a first axis ‘A’. A steering wheel (not shown) is attached to one end of the steering shaft 12. Another end of the steering shaft 12 is coupled a steering gear (not shown). The upper jacket 14 surrounds and supports the steering shaft 12 via bearing disposed between the steering shaft 12 and upper jacket 14. In an exemplary embodiment, the upper jacket 14 extends coaxially with the steering shaft 12. The steering shaft 12 is rotatably connected to the upper jacket 14.

A lower jacket, or telescope clamp 20, at least partially surrounds and supports the upper jacket 14. The telescope clamp 20 includes a body portion 22 which, in an exemplary embodiment, extends substantially around an outer circumference of the upper jacket 14 and extends coaxially with the upper jacket 14. An inner circumference of the body portion 22 substantially matches an outer circumference of the upper jacket 14.

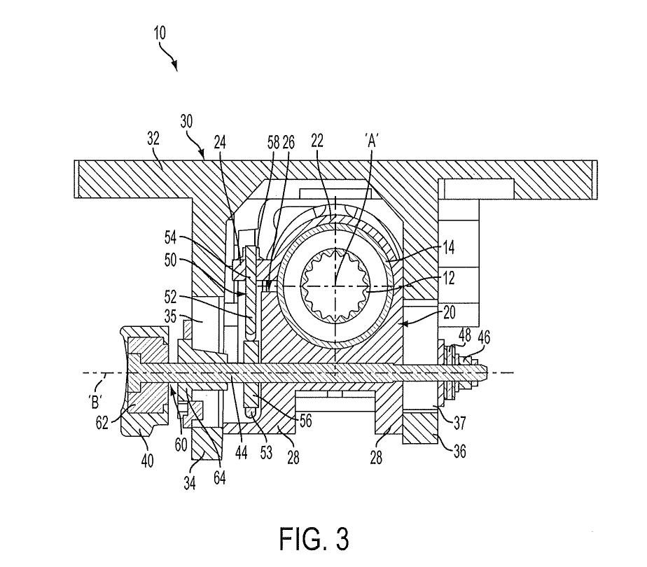

FIG. 3 is a cross section view taken at C-C in in FIG. 1, of the adjustable steering column according to an exemplary embodiment of the present invention. With reference to FIGS. 2 and 3, the telescope clamp 20 also includes a clamping leg 24 that extends outwardly or away from the body portion 22. In an exemplary embodiment, the clamping leg 24 extends in a generally radial direction from a point along the outer circumference of the upper jacket 14, but is not limited to such a configuration. A gap 26 is formed between the clamping leg 24 and part of the body portion 22 of the telescope clamp 20. The telescope clamp 20 may also include a plurality of feet 28 used for clamping in the rake direction as described further below. The steering shaft 12 and upper jacket 14 move relative to the telescope clamp 20 in the telescope direction during adjustment in the telescope direction.

With further reference to FIGS. 2 and 3, the adjustable steering column 10 also includes a rake bracket 30. In an exemplary embodiment, the rake bracket 30 includes a mounting section 32, a first leg 34 and a second leg 36. The mounting section 32 is configured to be secured to an adjacent vehicle component by suitable fasteners. In an exemplary embodiment, the mounting section 32 includes at least one opening configured to receive a fastener to be secured to the adjacent vehicle component.

The first leg 34 extends from the mounting section 32. In an exemplary embodiment, the first leg 34 extends generally perpendicularly from the mounting section 32, but is not limited to such a configuration. The second leg 36 is spaced from the first leg 34 and extends from the mounting section 32. In an exemplary embodiment, the second leg 36 extends generally perpendicularly from the mounting section 32 and parallel to the first leg 34. However, it is understood that the present invention is not limited to this configuration, and the second leg 36 may extend from the mounting section 32 at a non-perpendicular angle and may be non-parallel to the first leg 34. The first leg 34 and second leg 36 are spaced apart to receive to the telescope clamp 20, the upper jacket 14 and steering shaft 12 therebetween. The first leg 34 includes a first rake slot 35 and the second leg 36 includes a second rake slot 37.

The actuating lever 40 includes a handle portion 42 (FIG. 2) and is rotatable about a second axis ‘B’. A rake bolt 44 extends along the second axis ‘B’ and is coupled to the actuating lever 40 to rotate with the actuating lever 40.

The second axis ‘B’ is spaced from the first axis ‘A’. In an exemplary embodiment, the rake bolt 44 extends along the second axis ‘B’ from the actuating lever 40, through the first rake slot 35 of the first leg 34, between the first leg 34 and second leg 36, and through the second rake slot 37 of the second leg 36 to a position outside of a space defined between the first leg 34 and second leg 36. The rake bolt 44 may also extend through the telescope clamp 20. In an exemplary embodiment, the rake bolt 44 may extend through the body portion 22 of the telescope clamp 20.

A rake lock nut 46 is secured to an end of the rake bolt positioned adjacent to the second leg 36 and outside of the space defined between the first leg 34 and second leg 36. The rake lock nut 46 may be used to adjust lash along the rake bolt 44. The terminology “lash”, as used herein, may refer to, for example, gaps between parts which may result from a manufacturing process. The rake lock nut 46 may be adjusted along the length of the rake bolt 44 to move parts positioned along the rake bolt 44 closer together to take up any gaps formed between the parts. A thrust bearing 48 may also be positioned on the rake bolt 44.

During adjustment in the rake direction, the rake bolt 44 moves in the first and second rake slots 35, 37 of the respective first and second legs 34, 36. The telescope clamp 20, upper jacket 14 and steering shaft 12 also move relative to the rake bracket 30 in the rake direction.

The telescope lock 50 is connected to and extends away from the rake bolt 44. The telescope lock is connected to the telescope clamp 20 at the clamping leg 24 and operates the telescope clamp 20 to selectively apply or release a first clamping force to the upper jacket 14. The steering shaft 12 is axially retained within the upper jacket 14. Thus, with the first clamping force applied to the upper jacket 14, the upper jacket 14 and steering shaft 12 are secured against adjustment in the telescope direction. With the first clamping force released from the upper jacket 14, the upper jacket 14 and steering shaft 12 may be adjusted in the telescope direction. In an exemplary embodiment, the telescope lock 50 includes a tension bolt 52 having a first end 53 and second end 54, a tension bolt cam 56 and a tension bolt lock nut 58.

The tension bolt 52 extends away from the rake bolt 44. In an exemplary embodiment, the tension bolt extends along a third axis ‘C’ that intersects the second axis ‘B’. The first end 53 is positioned adjacent to the rake bolt 44 and communicates with the rake bolt 44 via the tension bolt cam 56 as described below. The second end 54 is connected to the telescope clamp 20. In an exemplary embodiment, the second end 54 extends through an opening in the clamping leg 24 and is fastened thereto with the tension bolt lock nut 58. Accordingly, movement of the tension bolt 52 may cause movement of the clamping leg 24 of the telescope clamp 20 via the tension bolt lock nut 58.

The tension bolt cam 56 is positioned on or adjacent to the rake bolt 44 and is configured to drive the tension bolt 52 to operate the telescope clamp 20 by moving the clamping leg 24 of the telescope clamp 20. The tension bolt cam 56 may be any suitable cam capable of converting rotational motion of the rake bolt 44 into linear, or other, motion of the tension bolt 52. In an exemplary embodiment, the tension bolt cam 56 may be a D or DD type cam. Further, it is preferred that the tension bolt cam 56 is operably connected with the rake bolt 44 in such a way as to limit or prevent lost motion between the rake bolt 44 and the tension bolt cam 56.

The tension bolt lock nut 58 is positioned on the second end 54 of the tension bolt 52. In an exemplary embodiment, the tension bolt lock nut 58 is threadably adjustable along the tension bolt 52 to adjust lash along the tension bolt 52. The tension bolt lock nut 58 may be a nylon lock nut that is secured in place using conventional threaded locking techniques so as to prevent unintentional adjustment. In operation of the telescope lock 50, the tension bolt lock 58 may act as a loading mechanism to apply a force to the clamping leg 24 of the telescope clamp.

As noted above, the terminology “lash”, as used herein, may refer to a gap between various parts resulting from a manufacturing or assembly process. Such gaps may result in lost motion during operation of the telescope lock. For example, an input motion may not result in a corresponding output motion while the gaps are being taken up. In an exemplary embodiment, the tension bolt lock nut 58 may be adjusted after initial assembly of the telescope lock 50 to take up any gaps between the parts of the telescope lock, thereby preventing or reducing lost motion during operation. In addition, the tension bolt lock nut 58 may be adjusted to take up any gaps between the telescope clamp 20 and the jacket 14 by acting on the clamping leg 24.

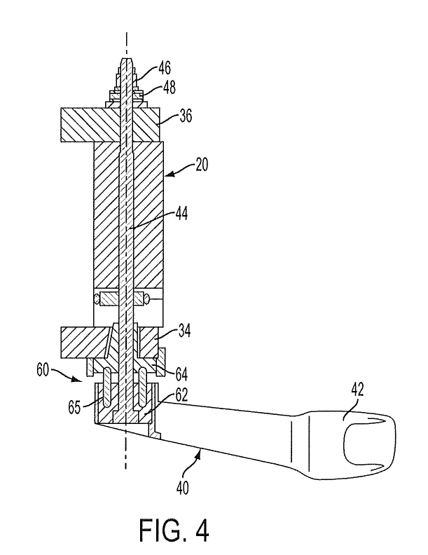

FIG. 4 is a cross section taken at D-D in FIG. 1 of the adjustable steering column 10 according to an exemplary embodiment of the present invention. With reference to FIGS. 3 and 4, a rake lock 60 is positioned along the rake bolt 44. The rake lock 60 is configured selectively apply or release a second clamping force to the rake bracket 30, and in turn, the telescope clamp 20. In an exemplary embodiment, the second clamping force is applied via the first leg 34 of the rake bracket 30 to the telescope clamp 20 to secure the telescope clamp 20, and in turn, the upper jacket 14 and steering shaft 12 against movement in the rake direction relative to the rake bracket 30. The second clamping force may be applied to the feet 28 of the telescope clamp 20. The telescope clamp 20 is movable in the rake direction between the first and second legs 34, 36 when the second clamping force is released. Accordingly, in this condition, the steering shaft 12 may be adjusted in the rake direction.

In an exemplary embodiment, the rake lock 60 is a cam mechanism comprising a first cam part 62 and second cam part 64. The first and second cam parts 62, 64 are positioned on the rake bolt 44. One of the of the cam parts is rotatable relative to the other. Relative rotation between the cam parts 62, 64 causes one cam part to move axially away or toward the other cam part, thereby applying or releasing the second clamping force along the second axis ‘B’.

In an exemplary embodiment, the first cam part 62 is overmolded within the actuating lever 40 and rotates with the actuating lever 40 and rake bolt 44. The second cam part 64 moves axially along the rake bolt 44 in response to rotation of the first cam part 62. Axial movement along the rake bolt 44 of the second cam part 64 causes the second cam part 64 to apply the second clamping force to the first leg 34 of the rake bracket 30. In turn, the second clamping force is applied from the first leg 34 to the telescope clamp 20, and to the second leg 36 via the telescope clamp 20.

In an exemplary embodiment, and with reference to FIG. 4, the cam mechanism of the rake bolt lock 60 may be a pin-type cam. In a pin-type cam, at least one pin 65 is disposed in respective recesses of the first cam part 62 and second cam part 64. In a first position, the at least one pin 65 is angled relative to the second axis ‘B’, thereby reducing or minimizing an axial distance between the first cam part 62 and second cam part 64. Rotation of one cam part relative to the other (in response to rotation of the rake bolt 44) causes the at least one pin 65 to move within the respective recesses toward a position that is generally parallel with the second axis ‘B’. During this movement, the at least one pin 65 pushes one of the second cam part 64 axially away from the first cam part 62. The movement of the second cam part 64 axially away from the first cam part 62 causes the second clamping force to be applied to the first leg 34 of the rake bracket 30.

It is understood that the cam mechanism of the rake lock 60 is not limited only to a pin-type cam, and that other suitable cams are envisioned. For example, other cam mechanisms that apply an axial clamping force to, or release the axial clamping from, the rake bracket 30, and in turn, to the telescope clamp 20 in response to rotation of the rake bolt 44 may be used as well. As non-limiting examples, the first and second cam parts may include a number of projections and recesses interfacing with and rotatably slidable relative to one another such that when peaks of respective projections are in contact with one another the axial clamping force is applied, and when a projection of one cam part is positioned within a recess of another cam part the axial clamping force is released. Alternatively, the first and second cam parts may include a series of balls and ramps where the balls are movable within respective ramps to move one cam part axially relative to the other in response to rotation of the rake bolt 44.

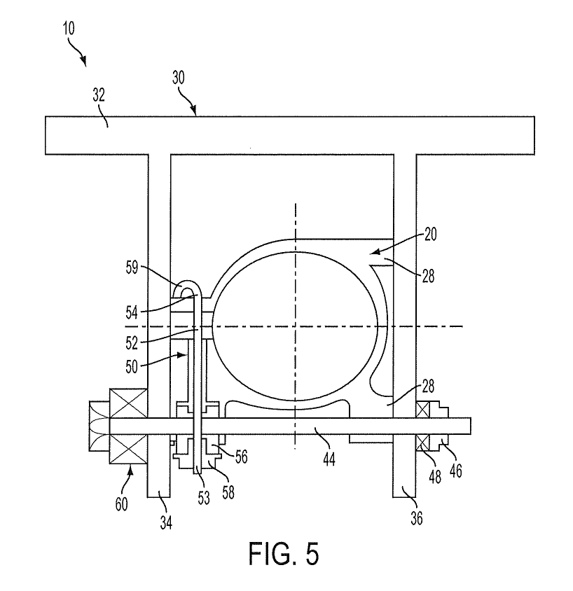

FIG. 5 illustrates an alternative exemplary embodiment of the present invention. It is understood that parts similar to those already described above are referred to with similar reference numbers. Referring to FIG. 5, the number and position of feet 28 of the telescope clamp may be varied in comparison to the exemplary embodiments above. For example, the telescope clamp may include two feet 28 abutting the second leg 36 of the rake bracket 30. In addition, the rake bolt 44 may extend through the feet 28 of the telescope clamp 20.

With further reference to FIG. 5, the tension bolt lock nut 58 may be positioned at the first end 53 of the of the tension bolt 52. In this exemplary embodiment, the tension bolt 52 includes another loading mechanism or connection, such as a tab 59 at the second end 54 to apply the force to the clamping leg 24. The features shown in the exemplary embodiment of FIG. 5 may be used together with, or in place of the features described in the exemplary embodiments above, and vice versa.

In operation of an exemplary embodiment of the present invention, the actuating lever 40 is rotated in a first direction and operates the rake lock 60. The first cam part 62 and the rake bolt 44 rotate together with the actuating ever 40 in the first direction. Rotation of the first cam part 62 in the first direction causes the second cam part 64 to move axially away from the first cam part 62 on the rake bolt 44 along the second axis ‘B’. The second cam part 64 applies the second clamping force to the first leg 34 of the rake bracket 30. In turn, the second clamping force is applied from the first leg 34 to the telescope clamp 20. A reaction clamping force is applied by the rake lock nut 46, thrust bearing 48, and second leg 36 positioned on an opposite side of the telescope clamp 20 from the rake lock 60. With the second clamping force applied, the telescope clamp 20, and in turn, the upper jacket 14 and steering shaft 12, is secured against adjustment in the rake direction. In addition, a friction force between the second cam part 64 and the first leg 34 resists movement of the rake bolt 44 in the first rake slot 35 of the first leg 34, further securing the telescope clamp 20 against adjustment in the rake direction.

Rotation of the rake bolt 44 in the first direction also operates the telescope lock 50. In particular, rotation of the rake bolt 44 operates the tension bolt cam 56. The tension bolt cam 56 is operably connected to the first end 53 of the tension bolt 52 and drives the tension bolt 52 in a locking direction in response to rotation of the rake bolt 44 in the first direction. In an exemplary embodiment, the tension bolt 52 is driven toward the rake bolt 44 such that a loading mechanism at the second end 54 of the tension bolt 52, such as the tension bolt lock nut 58 (FIGS. 2 and 3) or tab 59 (FIG. 5), acts on the clamping leg 24 of the telescope clamp 20. This movement of the tension bolt 52 toward the rake bolt 44 causes the tension bolt 52, via the tension bolt lock nut 58, to pull the clamping leg 24 of the telescope clamp 20 toward the rake bolt 44 as well. Movement of the clamping leg 24 toward the rake bolt 44 causes the gap 26 to decrease in width. Accordingly, the first clamping force is applied to the upper jacket 14 by the telescope clamp 20. With the first clamping force applied to the upper jacket 14, the steering shaft 12 and upper jacket 14 are secured against adjustment in the telescope direction.

That is, the first clamping force and second clamping force may be applied through operation of the telescope lock 50 and rake lock 60 in response to rotation of the actuating lever 40. With the first and second clamping forces applied to the upper jacket 14 and telescope clamp 20, respectively, the steering shaft 12 is secured against adjustment in the rake and telescope directions, and thus the steering column 10 is in a clamped or locked condition.

Rotation of the actuating lever 40 in a second direction, opposite to the first direction, actuates the steering shaft 12 from the clamped or locked condition to an unclamped or unlocked condition. In particular, rotation of the actuating lever 40 in the second direction operates the rake lock 30 by rotating the rake bolt 44 and first cam part 62 in the second direction. The second cam part 64 is urged toward the first cam part 62 due to elasticity in the system and the second clamping force applied along the second axis ‘B’. Rotation of the first cam part 62 in the second direction allows the second cam part 64 to move axially toward the first cam part 62 along the rake bolt 44. Accordingly, the second clamping force is released from the first leg 34, and in turn, the telescope clamp 20. In addition, the friction force between the second cam part 64 and the first leg 34 is released. With the friction force and second clamping force released, the telescope clamp 20 is movable in the rake direction, and thus, the upper jacket 14 and steering shaft 12 are adjustable in the rake direction.

Rotation of the rake bolt 44 in the second direction also operates the telescope lock 50. In particular, rotation of the rake bolt 44 operates the tension bolt cam 56. The tension bolt cam 56 drives the tension bolt 52 in an unlocking direction in response to rotation of the rake bolt 44 in the second direction. In an exemplary embodiment, the tension bolt 52 is driven away from the rake bolt 44. The clamping leg 24 is urged toward an unloaded condition due to the geometry and elasticity of a material from which the clamping leg 24 is made. Movement of the tension bolt 52 away the rake bolt 44 causes the loading mechanism, such as tension bolt lock nut 58 (FIGS. 2-3) or tab 59 (FIG. 5), to release a force applied to the clamping leg 24 and allows the clamping leg 24 to move toward the unloaded position, i.e., away from the rake bolt 44. Movement of the clamping leg 24 away from the rake bolt 44 causes the gap 26 to increase in width. Accordingly, the first clamping force is released from the upper jacket 14 by the telescope clamp 20. With the first clamping force released from the upper jacket 14, the upper jacket 14 and steering shaft 12 are adjustable in the telescope direction.

That is, the first clamping force and second clamping force may be released through simultaneous operation of the telescope lock 50 and rake lock 60 in response to rotation of the actuating lever 40. With the first and second clamping forces released from the upper jacket 14 and telescope clamp 20, respectively, the steering shaft 12 may be adjusted in the rake and telescope directions, and thus the steering column 10 is in the unclamped or unlocked condition.

In the exemplary embodiments above, lash along the rake bolt 44 and/or in the rake lock 50, and lash in the telescope lock 60 and/or between the telescope clamp 20 and upper jacket 14 may be individually adjusted. This may be done by adjusting the rake lock nut 46 and the tension bolt lock nut 58 after initial assembly of the adjustable steering column to account for any part to part variation resulting from the manufacturing or assembly process. Further, the rake lock nut 46 and the tension bolt lock nut 58 may be adjusted to set a preload, if desired, with the steering column in the locked condition. Further still, the rake lock nut 46 and the tension bolt lock nut 58 may be adjusted to set a preload in the unlocked condition as part of the elimination or reduction of lash.

Accordingly, in the exemplary configurations described above, lash along the rake bolt 44 and tension bolt 52 may be individually adjusted. Thus, performance characteristics such as the stiffness while clamped, holding load while clamped in two axes of motion and resistance to adjustment while unclamped in two axes of motion, may be adjusted at assembly.

That is, because the telescope clamp 20 and telescope lock 50 are decoupled from the rake lock 60, the performance characteristics of the adjustable steering column 10 may be met by individually adjusting lash for each of the telescope lock 50 and the rake lock 60 along the rake bolt 44. For example, in the exemplary embodiments described above, a high hold loading while clamped and low resistance to adjustment may be met, while still meeting desired performance characteristics for low actuating lever effort. The tension bolt cam 56 may be tuned to suit the stiffness of a particular joint, and clearance to the cam 56 may be adjusted with the tension bolt lock nut 58 to account for part-to-part variations. Further, the rake lock nut 46 may be adjusted to meet performance characteristics regarding rake adjustment without affecting telescoping adjustment performance characteristics.

Stiffness of the adjustable steering column 10 may be enhanced by controlling a contact position of mounting feet on the telescope clamp 20. The effort required to operate the actuating lever 40 may be reduced by balancing jacket clamp 20 loads against rake bracket 40 loads. In the exemplary embodiments above, gaps along the separate axes of motion are no longer additive, so that for a given direction of adjustment, increased mechanical advantage may be realized.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. An adjustable rake and telescope steering column comprising:
a rake bracket comprising a first leg and a second leg;
a steering shaft extending within an upper jacket along a first axis between the first leg and second leg;
a telescope clamp positioned about the upper jacket;
a telescope lock connected to the telescope clamp and configured to operate the telescope clamp to selectively apply a first clamping force to the upper jacket to secure the steering shaft against adjustment in a telescope direction;
an actuating lever coupled to a rake bolt, the rake bolt extending along a second axis through the first leg and second leg and spaced from the upper jacket; and
a rake lock positioned on the rake bolt and configured to selectively apply a second clamping force in a direction along the second axis to secure the steering shaft against adjustment in the rake direction.

2. The adjustable rake and telescope steering column of claim 1, wherein the telescope lock comprises a tension bolt that is a driven in a direction intersecting the second axis.

3. The adjustable rake and telescope steering column of claim 2, wherein the telescope lock further comprises a tension bolt cam operably connected to the rake bolt, the tension bolt having a first end connected to the tension bolt cam and a second end connected to the telescope clamp, wherein the tension bolt cam drives the tension bolt in response to rotation of the rake bolt.

4. The adjustable rake a telescope steering column of claim 3, wherein the telescope clamp comprises a body portion at least partially surrounding the upper jacket and a clamping leg extending outwardly from the body portion, the second portion of the tension bolt connected to the clamping leg.

5. The adjustable rake and telescope steering column of claim 4, wherein the telescope lock further comprises a tension bolt lock nut attached to the tension bolt, the tension bolt lock nut movable to adjust lash along the tension bolt.

6. The adjustable rake and telescope steering column of claim 5, wherein the tension bolt cam drives the tension bolt in an locking direction in response to rotation of the rake bolt in a first direction and drives the tension bolt in an unlocking direction in response to rotation of the rake bolt in a second direction, opposite to the first direction.

7. The adjustable rake and telescope steering column of claim 6, wherein the locking and unlocking directions are linear directions extending along a third axis intersecting the second axis.

8. The adjustable rake and telescope steering column of claim 6, wherein the tension bolt lock nut is positioned at the second end of the tension bolt and applies a force to the clamping leg during movement of the tension bolt in the locking direction.

9. The adjustable rake and telescope steering column of claim 6, wherein the tension bolt lock nut is positioned at the first end of the tension bolt, and the telescope lock further comprises a tab at the second end of the tension bolt, the tab configured to apply a force to the clamping leg during movement of the tension bolt in the locking direction.

10. The adjustable rake and telescope steering column of claim 4, wherein movement of the tension bolt in the locking direction deflects that clamping leg so as to apply the first clamping force to the upper jacket.

11. The adjustable rake and telescope steering column of claim 6, wherein the rake lock comprises a cam mechanism having a first cam part and a second cam part axially movable relative to the first cam part along the rake bolt in response to rotation of the first cam part.

12. The adjustable rake and telescope steering column of claim 11, wherein the first cam part is overmolded with the actuating lever and is rotatable therewith.

13. The adjustable rake and telescope steering column of claim 11, wherein the second cam part moves axially away from the first cam part to apply the second clamping force in response to rotation of the rake bolt in the first direction.

14. The adjustable rake and telescope steering column of the claim 13, wherein the second cam part moves axially toward the first cam part in response to rotation of the lock bolt in the second direction.

15. The adjustable rake and telescope steering column of claim 11, further comprising a rake lock nut positioned on the rake bolt, the rake lock nut movable to adjust lash along the rake bolt.

16. The adjustable rake and telescope steering column of claim 1, wherein the telescope lock is configured to apply the first clamping force and the rake lock is configured to apply the second clamping force in response to rotation of the rake bolt in a first direction.

17. The adjustable rake and telescope steering column of claim 16, wherein the rake lock moves along the second axis to apply the second clamping force, and the telescope lock moves in a direction that intersects that second axis to apply the first clamping force.

18. The adjustable rake and telescope steering column of claim 1, wherein the telescope clamp further comprises a plurality of feet.

19. The adjustable rake and telescope steering column of claim 1, wherein the second clamping force is applied to the telescope clamp via the rake bracket to restrict movement of the telescope clamp relative to the rake bracket in the rake direction, thereby securing the upper jacket and steering shaft against adjustment in the rake direction.
